(19) United States
(12) Patent Application Publication
(10) Pub. No.: US 2009/0024488 A1
(43) Pub. Date: Jan. 22, 2009

(54) SYSTEMS AND METHODS FOR IMPLEMENTING CENTRALIZED WORKFLOW MANAGEMENT FOR MULTIPLE DISPARATE ENTITIES

(75) Inventor: Jonathan Romley, Beverly Hills, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: ArtistForce, Inc., Beverly Hills, CA (US)

(21) Appl. No.: 12/174,557

(22) Filed: Jul. 16, 2008

Related U.S. Application Data
(60) Provisional application No. 60/950,056, filed on Jul. 16, 2007.

(51) Int. Cl. G06Q 30/00

(52) U.S. Cl. 705/26

(57) ABSTRACT

Systems and methods are provided to facilitate services for performing artists and their respective agents, managers, and other business representatives to interact and transact commerce with each other, and with buyers or purchasers of performing arts appearances within a secure online environment. In certain aspects, the systems and methods of the present invention advantageously leverage an online community and electronic processes of traditional entertainment procurement, and provide multiple entities with a customized cross-platform over the Internet without requiring certain relationship management software platforms.

### CROSS-REFERENCES TO RELATED APPLICATIONS

The present application claims benefit to U.S. Provisional Patent Application No. 60/950,056, filed Jul. 16, 2007, the complete disclosure of which is incorporated herein by reference.

### BACKGROUND

The present invention is directed to systems and methods for networking and workflow management in a multi-entity or multi-party database system. In particular, the present invention provides a networking system for multiple disparate parties or entities and a centralized workflow system that allows these disparate parties to transact business in a secure environment.

The advent of computer networks, such as the Internet, offers geographically distributed users unprecedented opportunities to interact and transact commerce with each other. Today, the Internet becomes an integral part of most people's daily lives, with people shopping, communicating, and networking. As the popularity of the Internet increases, many users want to sell or offer their talent and abilities to potential buyers or to seek appropriate personals for various events or positions over the Internet. To accommodate these needs, some service providers offer resume posting services or online social networks where users can exchange information about same or similar interests.

Due to the ever fast changing live entertainment trends, appearance buyers such as talent buyers, venue managers, promoters, etc. want to locate talent who can be the best fit for a certain performing arts appearance (e.g., concerts, personal appearances, speaking engagements, comedy shows, variety shows, theatrical productions etc.) as quick as possible without being restricted by geographic or time limitations. Likewise, artists and talent who offer performing appearance want to review or get notified about potential leads or offers from the appearance buyers. Further, the appearance buyers and talent (or their respective agents) want to negotiate the terms and conditions or exchange documents to produce a contract without being restricted by geographic or time limitations. However, there are not many service providers that facilitate the demand from the entertainment industries, such as electronic procurements among multiple users or entities, managing profiles of users, enabling interactions and commercial transactions with each other, and with buyers or purchasers, or the like in one secure online environment. Thus, users have no other choices but to use several different service providers, each of which offers one or more limited services such as resume services, agent services, document processing services, online social networks, media posting services, advertisement services, financial transaction services, etc. In this environment, a user needs to manage and keep track of complicated documents and information material created or obtained from several different service providers based on a particular workflow. This is very troublesome, error prone and costly.

### SUMMARY

The present invention is directed to systems and methods for networking and workflow management in a multi-entity or multi-party database system that is web based. In particular, the present invention provides a networking system for multiple disparate parties or entities and a centralized workflow system that allows these disparate parties to transact business in a secure environment.

In an accordance with certain embodiments, systems and methods are provided to facilitate services for performing artists and their respective agents, managers, and other business representatives to interact and transact commerce with each other, and with buyers or purchasers of performing arts appearances within a secure online environment. In certain aspects, the systems and methods of the present invention advantageously leverage an online community and electronic processes of traditional entertainment procurement, and replace and enhance the non-existent or legacy relationship management software platforms with a customized cross-platform on-demand interactive solution.

In an accordance with other embodiments, the systems and methods utilize a web application that stores and processes multimedia information and profiles on active performing artists, talent agencies, talent agents, managers, record labels, A&R representatives, talent buyers, promoters, venues, and other relevant industry professionals. These profiles may be accessed by other users, thereby assisting these users in networking with each other in an online community format for the purpose of developing business relationships. These profiles also reflect the relationships between the various users such as artists/agents/agency etc. thereby assisting in networking within the online community for the purpose of developing business relationships.

According to certain aspects, on-demand application modules such as CRM and ERP type modules are provided to facilitate data and workflow management. In one embodiment, for example, an offer/booking manager module is provided that enables users to develop, manage and transact electronic commerce related to artist performances (e.g., appearance bookings). The offer/booking manager module may include sub-modules that allow entities to generate and modify offers, to generate and modify contracts and to track data related to bookings.

In accordance with one embodiment, a system provides electronic commerce services among several users in an entertainment industry. The system comprises one or more data stores that store user account information, user profile information and workflow documents. The system comprises a computing device that is operable to provide services for a first user to create a first offer to purchase appearance, and present the first offer to a second user, wherein the second user is identified as a recipient of the first offer and allowed to view the first offer through the system. The second user can submit a response to the first offer, indicating that the first offer is accepted, rejected, or modified. If the response indicates the first offer is accepted, a contract is generated in accordance with the first offer. If the response indicates that the first offer is modified, a second offer is created including the modification and presented to the first user as a new offer. The computing device receives a response from the first user, indicating that the second offer is accepted, rejected or modified. If the response indicates the second offer is accepted, a contract is generated in accordance with the second offer. If not, then system allows for this scenario to go on and on to facilitate a negotiation process.

In accordance with another embodiment, a system provides entertainment networking and procurement services among several users in electronic commerce. The system comprises a profile module for creating and managing profile information of a first user, the profile information including media content uploaded by the first user, and an offer module for enabling the first user to create an offer for a second user and to view or modify the created offer. The first user and the second user are allowed to interact with each other to negotiate the created offer. The system further comprises a document module for allowing the user to create and manipulate a plurality of documents created while transacting electronic commerce and a financial transaction module for receiving a request of a financial transaction, forwarding the request to a secured financial service provider to facilitate the financial transaction, receiving the result and notifying a result of the financial transaction.

### BRIEF DESCRIPTION OF THE DRAWINGS

FIGS. 1A and 1B are pictorial diagrams showing an exemplary computing environment in which embodiments may be implemented;

FIG. 2 is a block diagram of how the system facilitates services for users to interact and transact commerce with each other, including several module components in accordance with one embodiment;

FIG. 3 is an example screen depicting a home page generated while a user interacts with the system in accordance with one embodiment;

FIGS. 4A-4B are example screens depicting profile information that is presented to a user in accordance with one embodiment;

FIG. 5 is an example screen depicting a Web page generated while a user reviews an offer in accordance with one embodiment;

FIGS. 6A-6D are block diagrams depicting an example of workflow for generating and processing offers according to one embodiment;

FIG. 7 is a flow diagram of a routine used by an offer/booking management module in accordance with one embodiment;

FIG. 8 is a flow diagram of subroutine used in the routine depicted in FIG. 7; and

FIG. 9 is a simple block diagram depicting an example of interactions among appearance purchaser, talent, and agent in typical entertainment procurement.

### DETAILED DESCRIPTION OF THE INVENTION

Systems and methods in accordance with various embodiments of the present disclosure may overcome one or more of the aforementioned and other deficiencies experienced in conventional approaches to providing a networking system for multiple disparate parties or entities and a centralized workflow system that allows these disparate parties to transact business in a secure environment.

### General System Overview

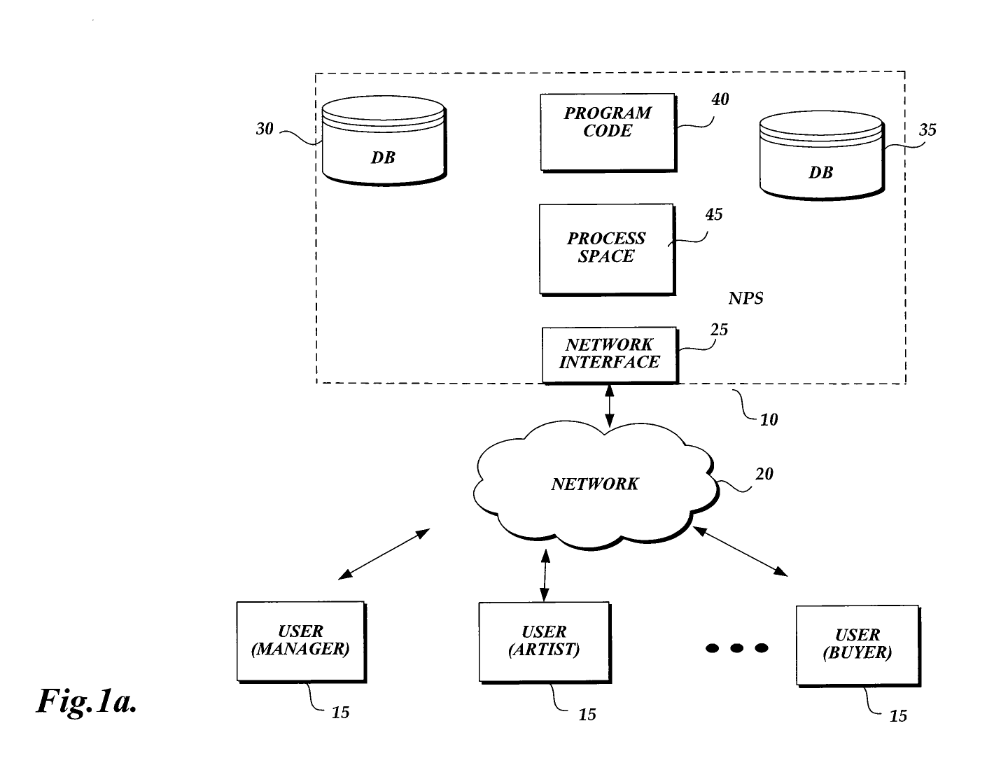

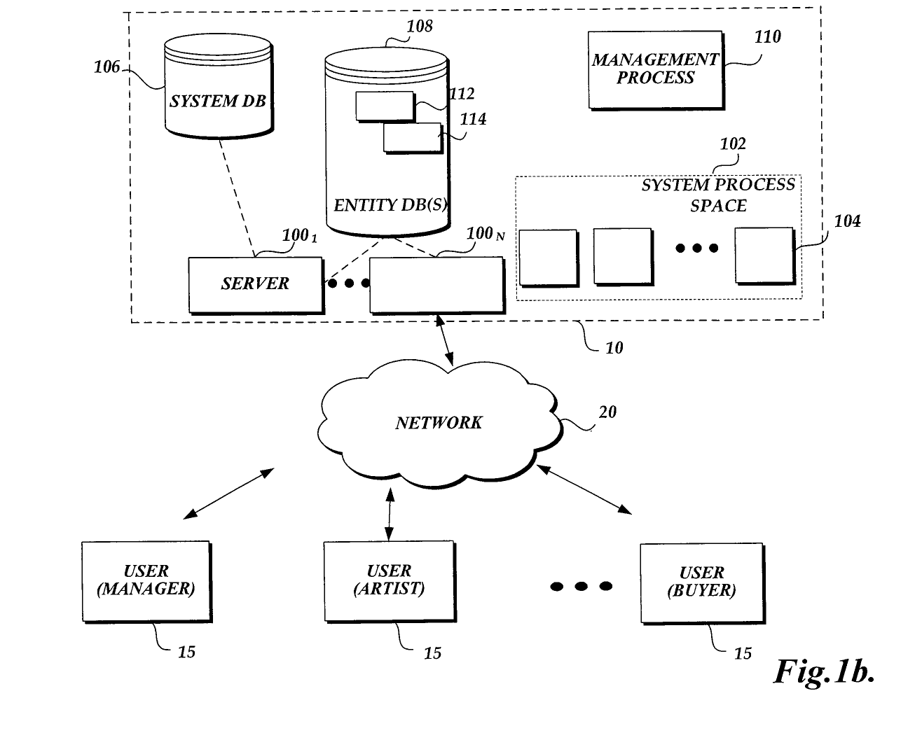

FIGS. 1a and 1b illustrate an environment wherein a multi-entity database system with networking and workflow capabilities according to various embodiments might be used. As illustrated in FIG. 1a (and in more detail in FIG. 1b) any user systems 15 might interact via a network 20 with an entertainment networking and procurement system (NPS) 10. The users of those user systems 15 might be users in differing capacities and the capacity of a particular user system 15 might be determined by permissions (permission levels) for the current user or by the type of user, e.g., agent, artist, manager, buyer, etc. For example, where an artist is using a particular user system 15 to interact with NPS 10, that user system has the capacities allotted to an artist. However, while a manager or purchaser/buyer is using that user system to interact with NPS 10, that user system has the capacities allotted to that manager or purchaser, respectively. Thus, different users will have different capabilities with regard to accessing and modifying application and database information, including profile information and contracting and booking information, depending on the type of user and/or a user's permission level.

Network 20 can be a LAN (local area network), WAN (wide area network), wireless network, point-to-point network, star network, token ring network, hub network, or other configuration. As the most common type of network in current use is a TCP/IP (Transfer Control Protocol and Internet Protocol) based network such as the global internetwork of networks often referred to as the “Internet” with a capital “I,” that will be used in many of the examples herein. However, it should be understood that the networks that the present invention might use are not so limited, although TCP/IP is the currently preferred protocol.

User systems 15 might communicate with NPS 10 using TCP/IP and, at a higher network level, use other common Internet protocols to communicate, such as HTTP, FTP, AFS, WAP, etc. As an example, where HTTP is used, user system 15 might include an HTTP client commonly referred to as a “browser” for sending and receiving HTTP messages from an HTTP server at NPS 10. Such HTTP server might be implemented as the sole network interface between NPS 10 and network 20, but other techniques might be used as well or instead. Preferably, each of the plurality of servers has access to the NPS's data, at least as for the users that are accessing that server.

In one aspect, the system shown in FIG. 1a implements a web-based customer relationship management (CRM) and enterprise resource planning (ERP) system. For example, in one aspect, NPS 10 can include application servers configured to implement and execute data management and workflow software applications as well as provide related data, code, forms, web pages and other information to and from user systems 15 and to store to, and retrieve from, a database system related data, objects and web page content. With a multi-entity system, data is preferably arranged so that data of one entity is kept logically separate from that of other entities so that one entity does not have access to modify another's data, unless such data is expressly shared. Users are generally given read access to profile information of other users.

One arrangement for elements of NPS 10 is shown in FIG. 1a, including a network interface 25, storage 30 for entity data, storage 35 for system data accessible to NPS 10 and possibly multiple entities, program code 40 for implementing various functions of NPS 10, and a process space 45 for executing NPS system processes.

Several elements in the system shown in FIG. 1a include conventional, well-known elements that need not be explained in detail here. For example, each user system 15 could include a desktop personal computer, workstation, laptop, etc., or a PDA, cell phone, or any other wireless access protocol (WAP) enabled device or any other computing device capable of interfacing directly or indirectly to the Internet or other network connection. User system 15 typically runs an HTTP client, e.g., a browsing program, such as Microsoft's Internet Explorer browser, Netscape's Navigator browser, Mozilla's Firefox browser, Opera's browser, Apple's Safari browser or any other browser, or a WAP-enabled browser in the case of a cell phone, PDA or other wireless device, or the like, allowing a user (e.g., subscriber to NPS 10) of user system 15 to access, process and view information, pages and applications available to it from NPS 10 over network 20. Each user system 15 also typically includes one or more user interface devices, such as a keyboard, a mouse, touch screen, pen or the like, for interacting with a graphical user interface (GUI) provided by the browser on a display (e.g., monitor screen, LCD display, etc.) in conjunction with pages, forms and other information provided by NPS 10 or other systems or servers. For example, the user interface device can be used to create offers or counter offers, create and modify contracts, select tabs, create and modify profile information, browse other user profiles, and otherwise allow a user to interact with the various GUI pages presented to a user of NPS 10.

As discussed above, the present invention is suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 15 and all of its components are operator configurable using applications, such as a browser, including computer code run using a central processing unit such as an Intel Pentium® processor or the like. Similarly, NPS 10 (and additional instances of NPS's, where more than one is present) and all of their components might be operator configurable using application(s) including computer code run using a central processing unit such as an Intel Pentium processor or the like, or multiple processor units. Computer code for operating and configuring NPS 10 to intercommunicate and to process web pages, applications and other data and media content as described herein is preferably downloaded and stored on a hard disk, but the entire program code, or portions thereof, may also be stored in any other volatile or non-volatile memory medium or device as is well known, such as a ROM or RAM, or provided on any media capable of storing program code, such as a compact disk (CD) medium, digital versatile disk (DVD) medium, a floppy disk, and the like. Additionally, the entire program code, or portions thereof, may be transmitted and downloaded from a software source, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, SOAP, RSS, etc.) as are well known. It will also be appreciated that computer code for implementing aspects of the present invention can be implemented in any programming language that can be executed on a server or server system such as, for example, in C, C++, HTML, any other markup language, SOAP, AJAX, Java, PHP, JavaScript, any other scripting language such as VBScript, and many other programming languages as are well known.

According to one embodiment, each NPS 10 is configured to provide web pages, forms, applications, data and media content to user systems 15 to support the access by user systems 15 as subscribing entities of NPS 10. As such, NPS 10 provides security mechanisms to keep each entity's data separate unless the data is shared. If more than one NPS is used, they may be located in close proximity to one another (e.g., in a server farm located in a single building or campus), or they may be distributed at locations remote from one another (e.g., one or more servers located in city A and one or more servers located in city B). As used herein, each NPS could include one or more logically and/or physically connected servers distributed locally or across one or more geographic locations. Additionally, the term “server” is meant to include a computer system, including processing hardware and process space(s), and an associated storage system and database application (e.g., a DBMS such as an OODBMS or a RDBMS) as is well known in the art. It should also be understood that “server system” and “server” are often used interchangeably herein. Similarly, the databases described herein can be implemented as single databases, a distributed database, a collection of distributed databases, a database with redundant online or offline backups or other redundancies, etc., and might include a distributed database or storage network and associated processing intelligence.

FIG. 1b illustrates elements of NPS 10 and various interconnections in more detail. In this example, the network interface is implemented as one or more HTTP application servers 100. Also shown is system process space 102 including individual entity process spaces 104, a system database 106, entity database(s) 108 and an entity management process space 110. Entity database 108 might be divided into multiple separate entity storage areas 112, which can be either a physical arrangement or a logical arrangement. Within each entity storage area 115, user storage 114 might similarly be allocated for specific objects associated with an entity. For example, entity storage areas 115 might include separate storage areas for artists, managers, agents and buyers. As another example, separate storage might be provided for offer objects or contract objects.

It should also be understood that each application server 100 may be communicably coupled to database systems, e.g., system database 106 and entity database(s) 108, via a different network connection. For example, one server 100₁ might be coupled via the Internet 20, another server 100_{N-1} might be coupled via a direct network link, and another server 100_{N} might be coupled by yet a different network connection. Transfer Control Protocol and Internet Protocol (TCP/IP) are preferred protocols for communicating between servers 100 and the database system, however, it will be apparent to one skilled in the art that other transport protocols may be used to optimize the system depending on the network interconnect used.

In certain aspects, each application server 100 is configured to handle requests for any user/entity. Because it is desirable to be able to add and remove application servers from the server pool at any time for any reason, there is preferably no server affinity for a user and/or entity to a specific application server 100. In one embodiment, therefore, an interface system (not shown) implementing a load balancing function is communicably coupled between the servers 100 and the user systems 15 to distribute requests to the servers 100. In one aspect, the load balancer uses a least connections algorithm to route user requests to the servers 100. Other examples of load balancing algorithms, such as round robin and observed response time, also can be used. For example, in certain aspects, three consecutive requests from the same user could hit three different servers, and three requests from different users could hit the same server. In this manner, NPS 10 is multi-entity, wherein NPS 10 handles storage of, and access to, different objects, data and applications for disparate users and entities.

As an example of storage, one entity might be an agency company that employs multiple talent agents, where each agent uses NPS 10 to manage their industry and client contacts (e.g., artists (clients), agents, venues, etc.) and booking workflow. Thus, an agent might maintain contact data, leads data, customer follow-up data, performance data, goals and progress data, etc., all applicable to that agent's personal client base (e.g., in entity database 108). In one NPS arrangement, since all of this data and the applications to access, view, modify, report, transmit, calculate, etc., can be maintained and accessed by a user system having nothing more than network access, the agent can manage his or her workflow from any of many different user systems. For example, if an agent is away from the office, the agent can use a wireless access device such as a PDA to obtain critical updates to, and modify, the workflow information.

While each user's data might be separate from other users' data regardless of the employers of each user, some data might include data shared or accessible by a plurality of users or all of the users for a given entity or group of users. Thus, there might be some data structures managed by NPS 10 that are allocated at a group level while other data structures might be managed at the user level. Because an NPS might support multiple entities including possible competitors, the NPS should have security protocols that keep data, applications and application use separate. Also, because many entities will opt for access to an NPS rather than maintain their own system, redundancy, up-time and backup are additional critical functions and need to be implemented in the NPS.

In addition to user-specific data and group-specific data, NPS 10 might also maintain system level data usable by multiple entities or other data. Such system level data might include industry reports, news, postings, and the like that are accessible and/or sharable among entities.

In certain aspects, client systems 15 communicate with application servers 100 to request and update system-level and entity-level data from NPS 10 that may require one or more queries to database system 106 and/or database system 108. NPS 10 (e.g., an application server 100 in NPS 10), in certain aspects, generates automatically one or more SQL statements (e.g., a SQL query) designed to access the desired information.

Each database can generally be viewed as a collection of objects, such as a set of logical tables, containing data fitted into predefined categories. A “table” is one representation of a data object, and is used herein to simplify the conceptual description of objects according to the present invention. It should be understood that “table” and “object” may be used interchangeably herein. Each table generally contains one or more data categories logically arranged as columns or fields in a viewable schema. Each row or record of a table contains an instance of data for each category defined by the fields. For example, an artist profile database may include a table that describes an artist with fields for basic contact information such as name, address, phone number, fax number, etc. An offer database may include another table that describes an offer, including fields for information such as venue, offer price, date, etc.

It is noted that embodiments and aspects are discussed herein in terms of their applicability to the entertainment industry, e.g., entertainment procurement and networking of individuals and entities in the entertainment industry. However, it should be appreciated that the various embodiments and aspects are applicable to other industries and communities. Examples of other industries or communities might include Outsourcing, Recruiting, Financial, Creative Services, Real Estate, Automotive, Equipment Leasing, Apartment-Rental Communities, etc.

### E-Commerce Social Network Server

In certain embodiments, NPS 10 includes an E-commerce social network server (herein after, a server) that offers services for performing artists and their respective agents, managers, and other business representatives that can interact and transact commerce with each other, and with buyers or purchasers (e.g., talent buyers, venues, promoters, etc.) of performing arts appearances within a secure online environment. The performing arts appearances may include concerts, personal appearances, speaking engagements, comedy shows, and the like. The server may provide various services related to web-based customer relationship management (CRM) and enterprise resource planning (ERP) so that users can communicate, manage relationships, negotiate offers, transact business, track bookings and share documents with other users. A user can solicit business opportunities through posting information that can be viewed by other users. For example, a performing artist may post content including a demo performance that can be viewed by other users. In certain aspects, only a web browser is needed to access the system to view data and communicate with other users.

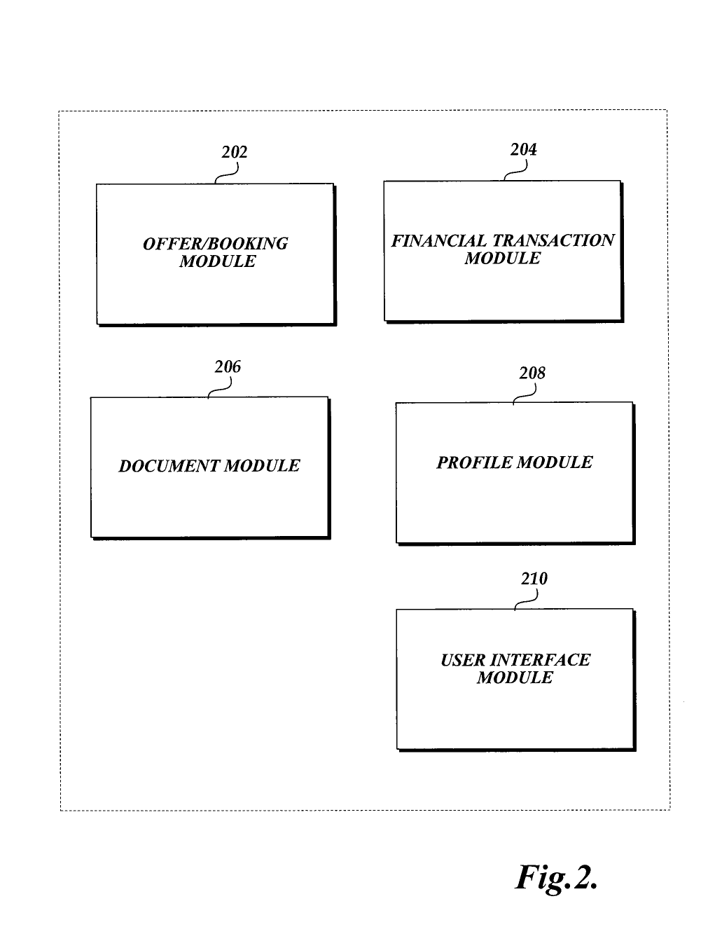

Referring now to FIG. 2, a server may comprise several modules, for example, an offer/booking management module 202 for providing user with the ability to generate and modify offers and contracts and to track booking data, a profile module 208 for creating and manipulating profile information of a user, a user interface module 210 for presenting information in a browser and allowing the user interact with the server, a financial transaction module 204 to facilitate financial transactions among users, a document module 206 for allowing users to create, search, edit, manage, archive, export, print, download, and/or organize documents. These modules are discussed in greater detail below.

It is noted that the above-mentioned modules are described herein for ease of discussion. Thus, the depiction of the server including theses modules should be taken as being illustrative in nature, and not as limiting to the scope of the disclosure. Further, it should be appreciated that these various modules are logical components, not necessarily actual and/or discrete components as they may be combined together or with other modules not discussed herein. Moreover, these various modules may be implemented in hardware, in software, or a combination thereof.

In order to maintain a secure online environment, in certain aspects, each user is required to register with a desired account type or role, for example, but not limited to, an artist, agent, agency, manager, buyer, venue, promoter, etc. As will be appreciated, one user can have a single role or multiple roles. In some instances, the server allows the general public to view some portion of information such as an advertisement, promotion of an event, etc. In some instances, the server allows only registered users to view some portion of information such as profile information, etc. Thus, certain information may be available to unregistered users while certain information may be available to registered users. As will be discussed in further detail below, each user may have a different level of right (permission level) for accessing other users' information. The level of right may be determined based on a role, account type, previous relationship with other users, a membership level, or the like. If a user is registered, they may login using their already determined user name and password. If a user is unregistered, they are recommended to set up a user account with the server and allowed to access information open to the public.

### Profile Module

In some embodiments, at the time of registration, the user may create a “profile” which can be presented to other users via a profile module. The term “profile”, as used herein, refers to collection of information about a user that is obtained from the user, or on behalf of the user, and stored in a database (e.g., a profile database) coupled to the server. The profile can include various content and information about the user. Certain types of profile information, such as name, address, phone number, desired account type, etc., may be requested by the server during a profile creating process. Once stored, each profile becomes part of a database. The profiles may be accessed by other users, thereby assisting these users in networking with each other for the purpose of developing business relationships. In certain aspects, a user can identify a portion of their profile information that may be shared with or viewed by other users. Additionally, a user can specify which portion of their profile information can be viewed by the public or only by registered users. In some embodiments, the profile module may include sub-modules, for example, a media module that process or upload multimedia content into a user's profile. In one embodiment, a user searches over the database to locate another user in order to establish some business relationships, verify the identity of another user, or simply obtain information about another user, etc.

The profile creation process may vary depending on a role (or an account type) for which the user is registering. For example, if a user is registering as an “artist”, the profile may include information such as name, photo, genre, skill, location, contact, business representative information, media content, etc. The term “artist”, as used herein, refers to talent or any user who can provide their performing appearance for compensation. The artist can have his or her skills, including, but not limited to, “Pop dance”, “Guitar”, “Singer”, “Painter”, “Drama”, “Comedian”, or like. In one embodiment, an artist can post media content to be downloaded from their profile by other users, in particular, business/industry users. The term, business/industry user, as used herein, refers to a buyer user (e.g., promoter, venue manager, etc.) or a representative user (e.g., agent, manager, agency, A&R representative, etc.), as opposed to an artist. The profile of the artist can include generally any information or content that the artist wants other users to be able to download and view. For example, an artist can upload music, video, PDF, images (album images), title files, etc. for inclusion in their profile page. The artist also includes information about riders (i.e. technical rider, hospitality rider, track show rider, tour rider, etc.) in their profile.

In one embodiment, the artist can also enter one or more highlighted skill, for example, Pop dance, Guitar, Singer, Painter, Sculpture, Drama, etc. in their profile. The artist can enter names of artists who their sound/style is similar to, or his/her performance fee range as maximum & minimum fee expected.

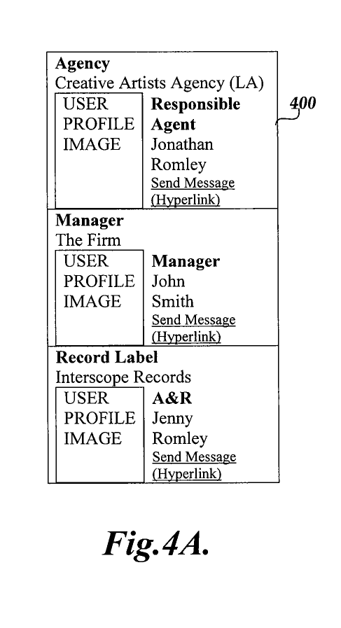

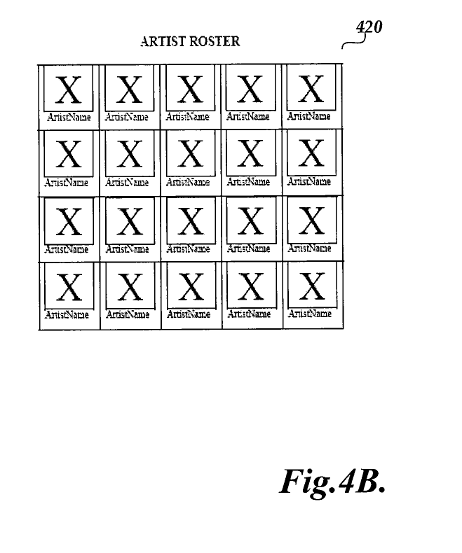

When a user is registering as a business/industry user, the profile may include user information similar to the user information discussed above in conjunction with the artist. The business/industry user may add other information that is specifically related to that given role or an account type. For example, a manager or an agent may specify their profile information such as representing artist's information (e.g., name of an artist, a link to the artist's profile, performance record, etc.), user verification information (e.g., agent's license copy and license verification), and the like. In one embodiment, a manager or an agent can add artists that they represent into their profile, and edit an individual artist's profile over which they have an adequate permission right. In one embodiment, a list of individual artist profiles is presented as a roster in the profile of the manager or the agent as shown in FIG. 4B.

After setting up an account and profile with the server, when the user signs in, a home page featuring a user-centric interface is displayed with the user specific details. Each user experience may be unique to their roles in their respective community or industry.

### User Interface Module and Home Page

As discussed above, a web application is utilized to store and process multimedia information and profiles on active performing artists, talent agencies, talent agents, managers, record labels, A&R representatives, talent buyers, promoters, and venues. The web application also interfaces with pertinent business resources to retrieve, store and process pertinent business data such as tour data including box office reports, artist performance feedback, business opportunities, industry news, and key signings, forums and classifieds.

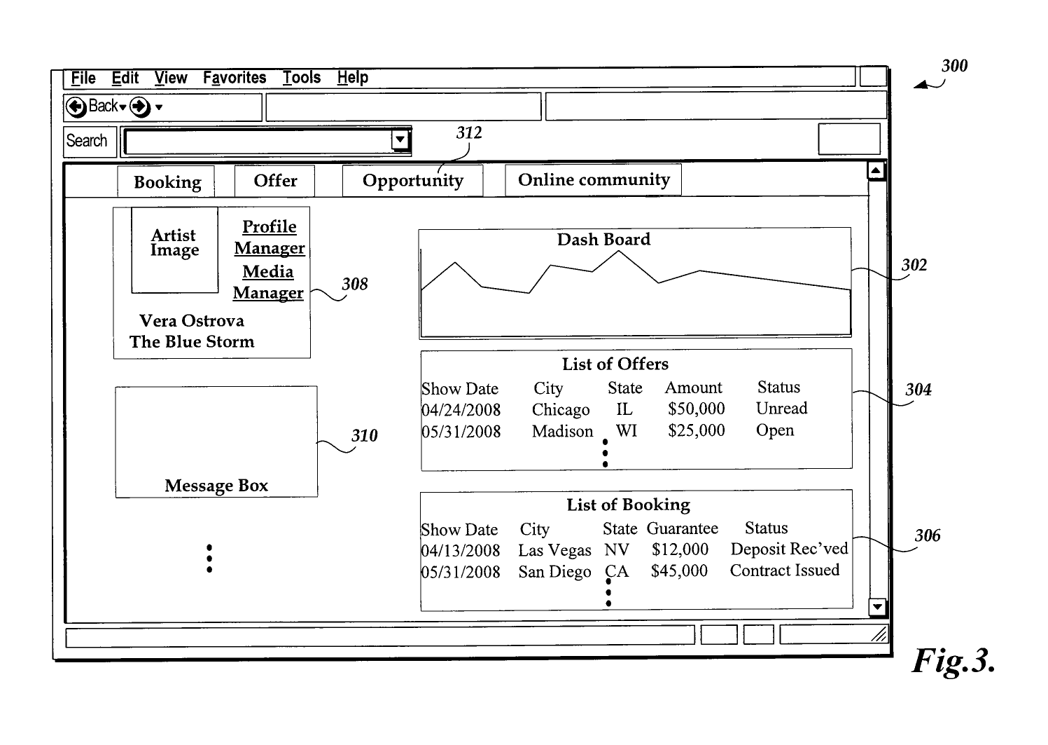

Referring now to FIG. 3, an exemplary graphic user interface (GUI), a home page 300, that the user is able to view via a browser on the user device is depicted. It should be understood that the home page 300 depicted herein is but one example and similar home pages with different features may be presented to different users based on their registered roles or profile information when logged in to the system. A home page also typically includes various selectable tabs for accessing information such as offers, contacts, bookings, mail, opportunities, etc. In certain embodiments, the server presents user specific details and information in a home page that generally includes several subsections, such as a Profile subsection 308, Dash board subsection 302, Offer subsection 304, Booking subsection 306, etc. In one embodiment, profile information for other users of interest can be viewed in a dedicated page (profile page) or window of the browser.

As shown, a home page typically presents the user with links to access and view the user's profile and to view other users' profiles. For example, a user can manage his or her profile through the user's home page, for example by selecting a profile manager menu option, media manager menu option, etc. in the profile subsection 308. Once the profile is created, the user is allowed to enter additional content and make changes in the content stored in the profile. Additionally, if the user has a proper level of access right, the user may be allowed to enter additional content and update other users' profiles. For example, an agent is allowed to upload content (music, video, PDF, images, etc.) for inclusion in the profile page of an artist whom the agent represents, on behalf of the artist.

As will be discussed in further detail below, an artist may receive booking/business inquiries through their home page (e.g., profile page). That is, a buyer user can send booking/business inquiries while reviewing the artist's profile page. In one embodiment, upon clicking on a profile of an artist, a message window where the buyer user can send booking/business inquiries to the artist may appear. It is noted, however, that booking/business inquiries can be transmitted from a buyer user to an artist in various manners. Once the booking/business inquiries are made, it would appear on the artist home page and associated venue or promoter home page. In some embodiments, upon receipt of the inquiries, the artist can communicate with the interested party (buyer or purchaser user) to negotiate or confirm the inquiries.

When confirmed, the artist can request the server (or a document module) to merge booking/business inquiry data into a document and produce a document file that can be printed, emailed, or sent to other users who are related to the artist. The inquiry is converted into a booking. Once a booking is marked confirmed, it would appear on the artist profile page and associated venue or promoter profile. If an artist who is associated with an agent and a manager receives a ‘lead’ inquiry, the artist will be given a choice indicating whether their agent or manager should receive a copy of this lead or the lead can be automatically forwarded. Such permission may be specified by the artist at registration and stored as profile information.

In one embodiment, a user may be provided with the information about the total number of received or confirmed offers, interested promoters, appearance programs, venue position, or the like. Such information may be presented in various ways. For example, the dashboard subsection 302 can include a graph of total offers and volume by month, geographical dash board, combination bar graph, line bar graph or the like. A geographical dashboard may be used to assist a user in locating his/her potential promoters, programs and venues based on geographic locations (e.g., state, city, a town, etc.) in the entire country. This would help an artist or agent to make decisions to select possible geographic area for future appearances and plan the tour. A combination bar graph is used to compare or contrast several factors to assists a user in analyzing the information about business and industry users.

In certain embodiments, information about other users who have some business relationships with a particular user may be presented to the particular user. For example, a list of profile pictures of business representatives (e.g., agent, agency, or manager) that are associated with an artist may be displayed in the artist's Web page (home page). Such a list may include information that is used by the user to easily recognize the identity of a business representative. For example, each picture may be labeled with the representative name, a sub-link below the representative name that enables a communication channel between the artist and the representative, as shown in FIG. 4A. For example, an email, a chat, an instant message, or other applications may be enabled for the artist to communicate with the business representative. If the artist is an unrepresented talent (or looking for new representatives), the server allows the artist to search for a potential representative from the users registered as agent/managers who have indicated they are seeking talent to represent.

In one embodiment, a user can obtain information about potential representatives who have indicated a desire to establish a new relation with talent. The service may have received a request from agents or manager and generate a list of available representatives. The server may present a hyperlink or a visual indicator that leads to a list of agents/managers who seek talent. In one embodiment, a menu option or tab selection to obtain such information may be presented in a home page, which leads to a Web page where the information about agents and managers who seek talents can be viewed. Referring now to FIG. 3, an “opportunity” tab selection 312 may be presented for that purpose. The server also provides an ability for a business user (e.g., agent, manager, promoter, venue manager, etc.) to identify or verify their relationship to a specific user on the system through the specific user's profile page, for example, by clicking a hyperlink button on the specific user's profile page, and submitting a request for verification and approval of a relationship. The relationship can be specified in the request. For example, when an agent wants to include an artist as their client, the agent may identify the artist in the request for approval of such relationship. Once approved, the artist's profile is associated with the agent profile. The artist's profile or a link to the artist's profile can appear on the agent's profile and the accounts for the artist and the agent are associated by relationship specified in the request.

In certain embodiments, a user (artist) can view the detail of received offers submitted to the user or business representatives for the user. As shown in FIG. 3, the “Offer” subsection 304 in the home page displays a list of offer summaries in a table format. Each offer summary may include a hyperlink or visual indicator to the full database record storing details of the offer. An artist is also able to view bookings (contracts) converted by the artist or business representatives on behalf of the artist. As shown, the “Booking” subsection 306 in the home page displays a list of booking summaries in a table format.

In some embodiments, most business/industry users (e.g., agent, agency, manager, promoter, etc.) may have a home page similar to the exemplary home page discussed above in connection with an artist. As discussed above, a business/industry user can be presented with other information such as a visual representation of the artists represented by the business user along with profile pictures and names which link to the artist's profile as shown in FIG. 4B.

In one embodiment, a user can access profile information about other registered users. A business/industry user, such as an agent, is also allowed to view or edit profile information of sub users, such as artists whom the business/industry user represents. The business/industry user can include their basic profile in profile information of each sub user, e.g., an artist, associated with the user. As mentioned above, a buyer user (e.g., a promoter, venue manger, etc.) can review audio and video of performing artists to identify talent or an artist who is suitable for an event or venue. In a home page for a business/industry user, other relevant information, such as real-time news, historical box office data, tour dates, sales statistics and live performance metrics, may be also presented.

### Offer/Booking Manager Module

According to certain aspects, the server includes on-demand application modules such as CRM and ERP type modules to facilitate workflow in a certain industry, for example, an entertainment industry. In one embodiment, for example, the server includes the offer/booking manager module that enables users to develop, manage and transact electronic commerce related to artist performances, such as appearance bookings. In certain aspects, the system also includes on-demand browser-based Video Conferencing, VoIP (Voice Over IP) and Instant Messaging capabilities, which require no software installation on the client side, allowing users to negotiate in real-time in a secure web-based software-free environment. According to one embodiment, an offer/booking manager module is provided to facilitate traditional workflow in entertainment industry.

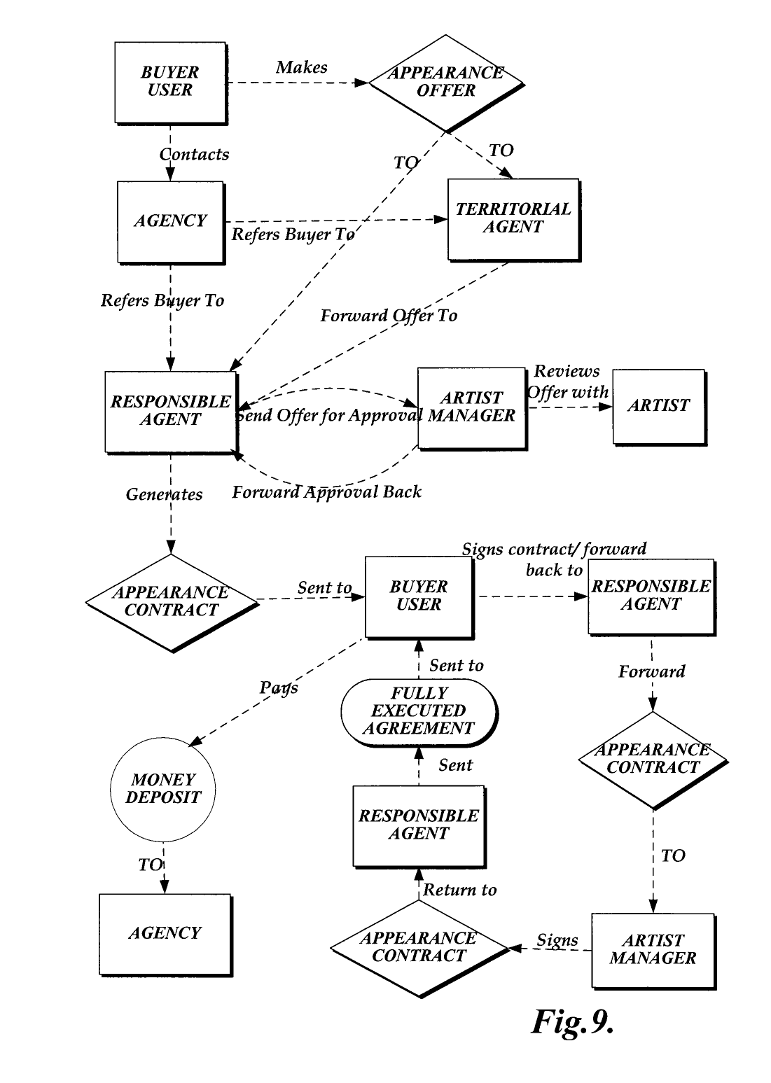

FIG. 9 shows an example of a booking process in typical entertainment procurement. In certain aspects of embodiments, the server (or the booking manager module) may replicate or optimize aspects of a real life booking process. For example, as shown in FIG. 9, multiple users need to communicate and negotiate with each other. In the real world, the communication can be restricted by time or geographic limitations. In certain aspects of embodiments, the server allows multiple users to communicate and negotiate with each other through various communication methods over networks so that negotiation can be done close to real time. In addition, the server provides services relating to generating, tracking, manipulating, and/or merging documents for the users. It is noted that the offer/booking management module may be a single module or include one or more sub-modules. In one embodiment, the booking management module includes several modules to handle various aspects of the booking process for various user types. The offer/booking manager module may allow users to make standard entertainment offers online, then to track and negotiate the deal with the other users.

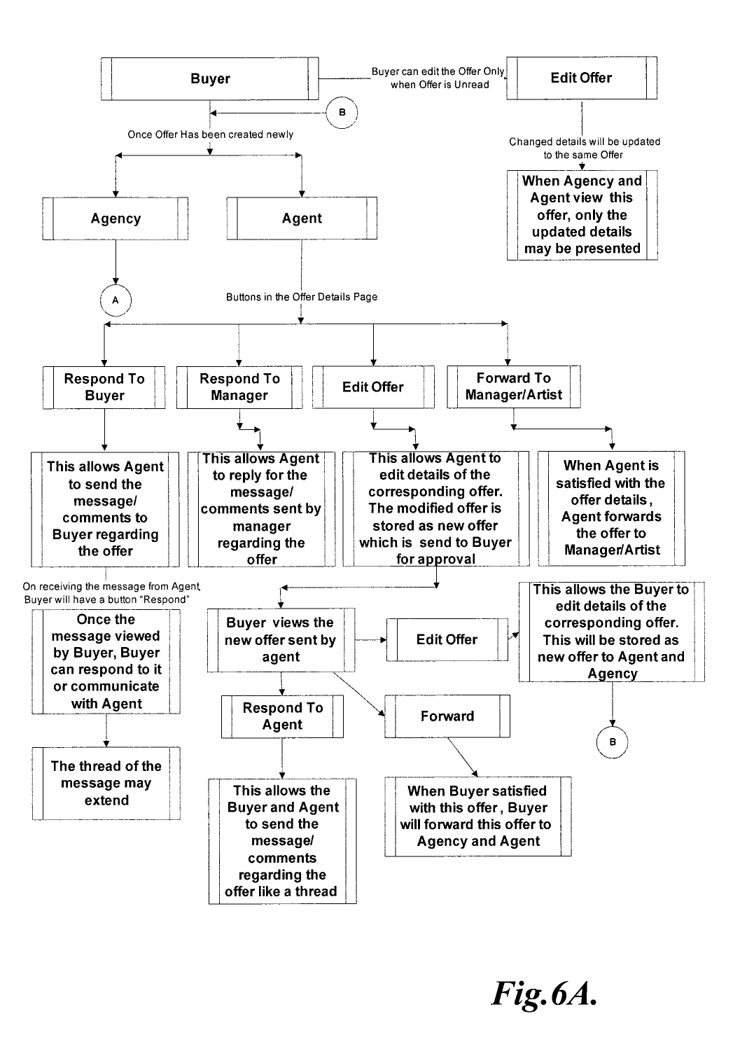

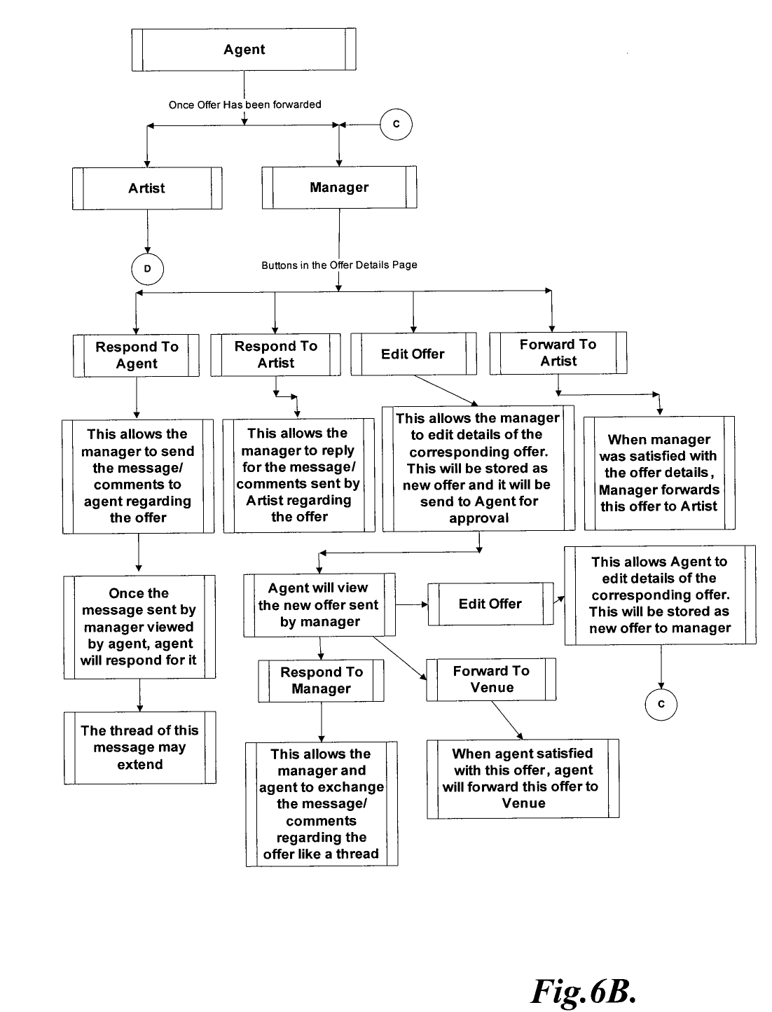

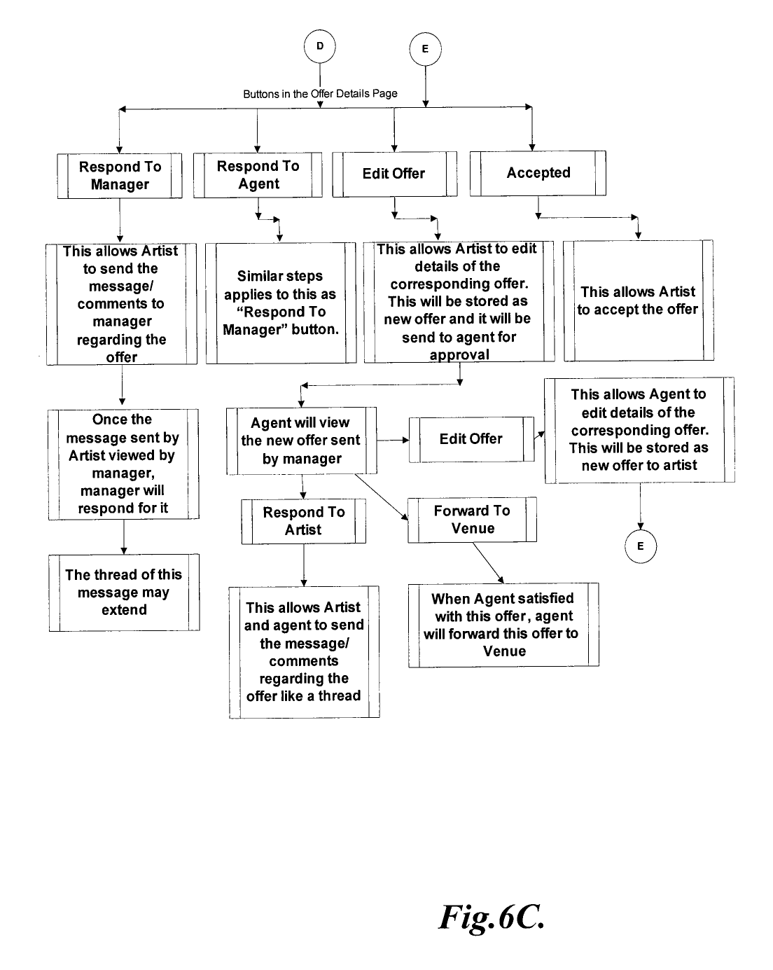

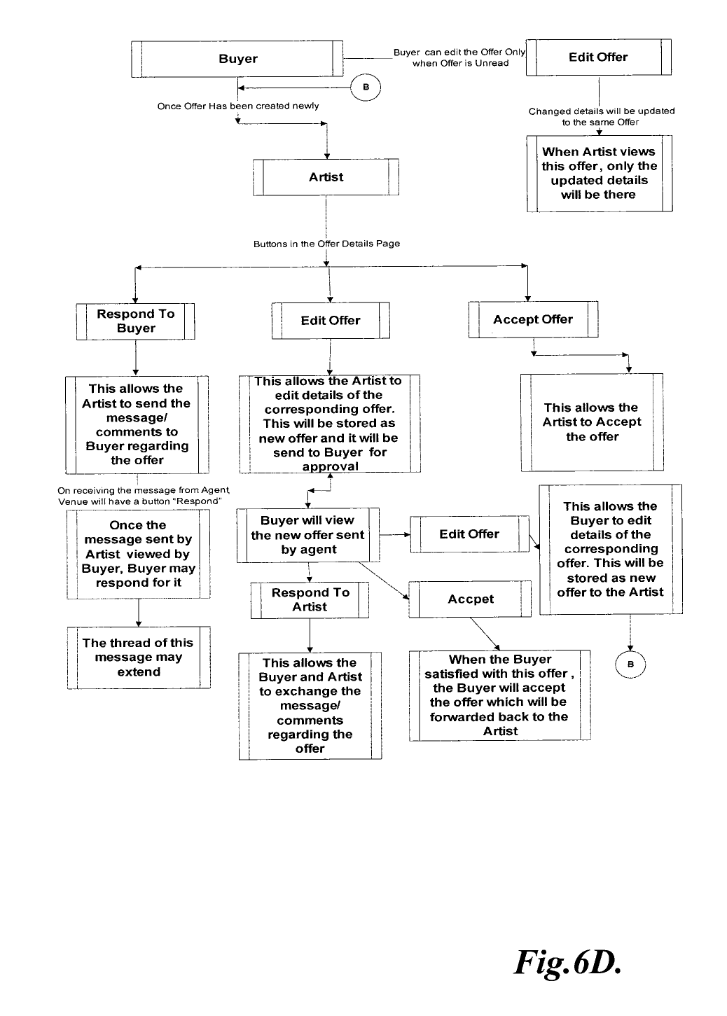

The offer/booking manager module allows a buyer user to create an offer for a recipient user, e.g., a talent, an agent of the talent. Once the buyer has created an offer, it can be made available to other users relevant to the offer. For example, the offer may be made available to a represented artist by providing the offer to an agent or an agency that represents the artist. For an unrepresented artist, the offer may be made available directly to the artist. An unrepresented artist generally refers to an artist with no agent or manager, but an unrepresented artist may have a record label. In general, the record company doesn't handle bookings for the artist. The agent or agency may review details of the offer and either respond, edit the offer or forward the offer to the artist or a manager for the artist. FIGS. 6A-6C illustrate an example of workflow provided by an offer/booking manager module for generating and processing offers for a represented artist according to one embodiment. FIG. 6D illustrates an example of workflow provided by an offer/booking manager module for generating and processing offers for an unrepresented artist according to one embodiment.

As shown in FIGS. 6A and 6D, a buyer, e.g., venue or other purchaser of talent (herein after, a buyer user), creates an offer. In some cases, the buyer knows a recipient of the offer, such as a representative of a particular artist, or an artist. Such information may be retrieved from the buyer user's contact information or history data such as previous booking records. In some cases, the buyer user may search which users can be a recipient of the offer. In certain embodiments, when the buyer user creates an offer, the server may allow the buyer to identify a recipient of the offer or locate an artist or an agent who can be a potential recipient of the offer. That is, the buyer can specify search criteria including price, genre, location, real-time availability, historical box office scores, chart history, and professional performance reviews. The server may conduct a search over databases based on the search criteria. In some embodiments, the server provides a GUI where the user can specify search criteria for locating the recipient.

The offer may typically include details such as date, time, place, price and other information. Such detail information is stored in the database as an offer object. Once created, the offer is made available to an identified recipient user and other users who have permission to access such an offer. For example, if an offer was made to an agent, agency, manager, an artist whom the agent represents or a manager of the artist can also access the offer as shown in FIGS. 6A-6C. Likewise, if an offer was made directly to an artist, a business representative of the artist can access the offer as shown in FIG. 6D. In some instance, an artist does not have an agent at the time of the offer, but finds one through the server.

In one embodiment, an offer may be made available by sending an e-mail including a link to the offer to the recipient. Alternatively, or additionally, information about the offer is displayed prominently on the home page when the recipient (e.g., agent or agency) logs in to the system. As shown in FIGS. 6A-6C, an agent or agency receiving an offer is given options to view the offer, respond to the buyer that created the offer, edit the offer details, comment on the offer details, forward the offer to another entity (e.g., manager or artist), etc. Once the created offer is edited by the artist or agent, a new offer including changes is created and stored as another offer object. The new offer (counter offer) may be reviewed by other users including the buyer user who initially created the offer. Similarly, a manager or artist in receipt of the offer may view, edit, reply, comment and forward the offer as well. Additional details are given in FIGS. 6A-6C; it should be appreciated that the workflow shown is but one example of an offer processing workflow. For artists that are not represented by a manager and/or agent or agency, the offer may be provided directly from the buyer to the artist. The artist is provided with options to view the offer, edit the offer, accept the offer, etc. In some embodiments, the buyer is allowed to edit a created offer if the offer was not viewed by the recipient user. As such, the server may have a set of business rules governing the offer workflow. Such business rules can be updated anytime when the industry's standard changes.

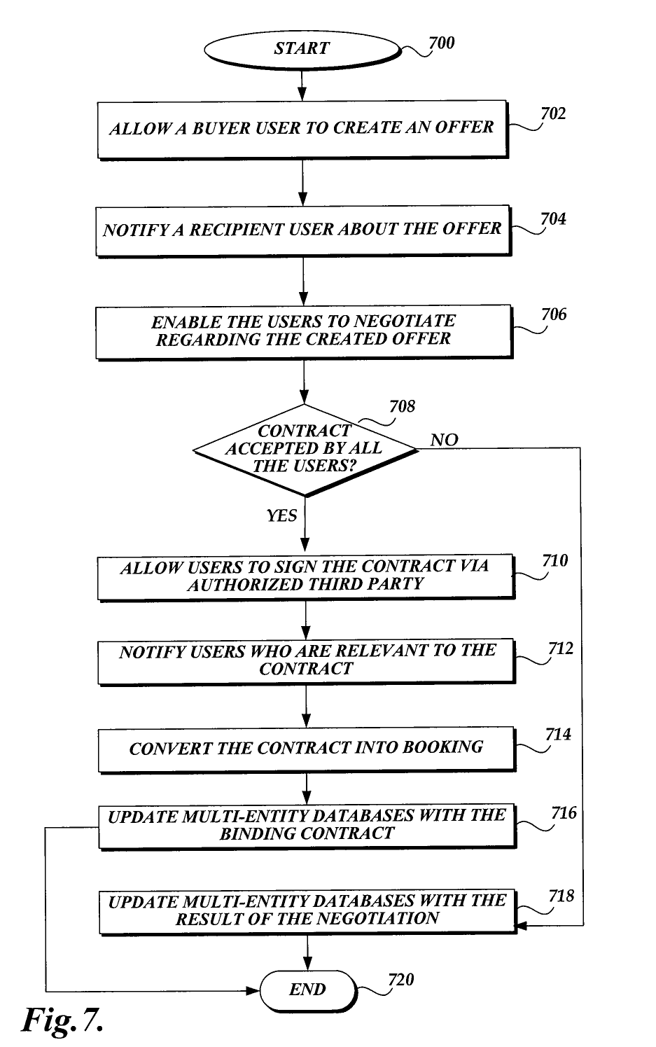

Referring now to FIG. 7, a flow diagram is shown of a routine for the server to allow users to make an offer, negotiate the offer, and generate a contract, in accordance with an embodiment of the present invention. For ease of discussion, it is assumed that one buyer user (promoter, venue manager, etc.) can make an offer or accept a counter offer. It is further assumed that the buyer user and a recipient user are already registered with the server. Beginning with block 702, the server allows a buyer user to create an offer. In one embodiment, the server may receive from a buyer user a request to create an offer through a home page of the buyer user. Upon receipt of the request, a GUI designated for creating an offer is presented to the buyer user. In some embodiment, a standard form may be presented in a user GUI. In some embodiments, several fields that are generally required for creating an offer may be pre-defined in the server. When a user wants to create an offer, the predefined fields are presented to obtain inputs from the user. The server may generate an offer based on the obtained inputs and store the offer in the database (an offer database).

As such, the buyer user may specify details of the offer along with information about a recipient of the offer by interacting with the server. As mentioned above, the buyer user may be allowed to search for potential recipients through the server. In one embodiment, the server conducts a search based on search criteria provided from the buyer user. The server may return search results, for example, a list of potential recipients. The buyer user can review the list of potential recipients, for example, profile of each recipient, or the like. The buyer, then, may identify a recipient by selecting one from the list of potential recipients. Additionally or alternatively, the buyer user provides a user identification of a recipient, etc. As such, the server may receive information about a recipient user and identify the recipient user and other users who are relevant to the offer. At block 704, the server notifies the identified user(s) about the created offer. As will be appreciated, a user can specify a desired method of notification in their profile. For example, a user may want to receive a notification via an email, voice mail, text message, SMS etc. Alternatively, the server may have a default method for notification if a user does not specify a desired method. As will be discussed in greater detail below, some users who are relevant to the offer may have a full or a limited access right to the created offer.

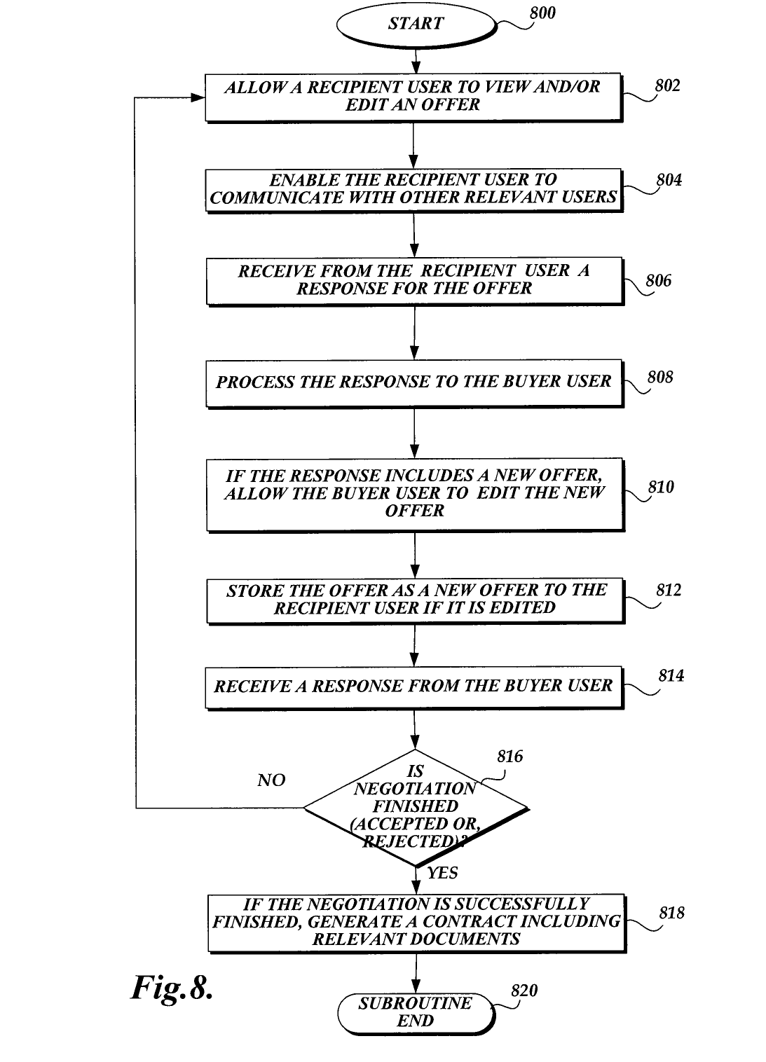

At block 706, the server allows users (a buyer user, a recipient user, other relevant users) to negotiate regarding the created offer. This step will be discussed in further detail in conjunction with FIG. 8 where a subroutine for the server to enable the users to communicate with each other while viewing and editing offers is depicted. At a decision block 708, it is determined as to whether the negotiation is successful to generate a contract. If the negotiation is successful (the offer is accepted by the users) then a contract is generated. Accordingly, the server enables each user to execute the contract with signatures at block 710. In one embodiment, a user can use their e-signatures or exchange a fax with signature documents. Before the execution of the contract, the identity of each user is verified through various secure methods. As will be appreciated, e-signatures may be maintained and authenticated by a third party service provider, such as EchoSign, etc. Optionally, the users relevant to the contract may be notified about the binding contract as illustrated at block 712.

In some embodiments, after the offer is converted into a binding contract at block 714, a record of booking is created and stored as a booking object at block 716. As discussed above, a list of bookings is presented to the users so that the user can review or become aware of the status of each booking. Referring back to the above-mentioned example of the home page in FIG. 3, an “Offer” subsection 304 and a “Booking” subsection 306 are displayed. As shown in the Offer subsection 304, offers submitted to an artist or representatives for the artist are presented in a visual summary, for example, a list/queue table format. The status of an offer includes “Unread,” “Reviewed,” “Rejected” “Accepted,” etc. In one embodiment, a visual representation of pipeline status of received offers is displayed. Each offer summary is a hyperlink to the full database record detail. Likewise, in the Booking subsection 306, bookings converted from the offers are presented in a visual summary, for example, a list/queue table format. Each booking summary includes a hyperlink or a visual indicator to the full database record detail.

In block 718, if the negotiation is not successful (the offer is rejected), the offer and the negotiated results may be stored as history in the database.

Referring now to FIG. 8, a flow diagram is shown of a subroutine for the server to enable multiple users to negotiate or communicate with each other over the Internet while viewing, editing and creating offers. At block 802, after a buyer user creates an offer, a recipient of the offer can view and/or edit the created offer. The created offer (a new offer) may be prominently displayed in a web page of the recipient user after the recipient user logs in to the server. In addition, the recipient user may receive a notification about the new offer via an email, voice mail, a text message, SMS etc. The recipient user may be allowed to view and/or edit the offer based on an access right for the offer. A certain recipient user, for example, an agent or agency may forward the received offer to other users, for example, an artist and/or a management of the artist for review.

In one embodiment, the artist and business representative of the artist (agent, manager, agency, etc.) are considered as users relevant to the offer. For ease of discussion, assume that an agent of an artist has received an offer from a promoter. The agent reviews the offer from the promoter. The agent can send a message or comments to the promoter regarding the offer. For example, the agent may thank for the business or ask some questions, etc. Likewise, the promoter can respond to the message from the agent. In some instances, the agent may want to communicate with the artist or a manager of the artist with respect to the received offer. The agent may communicate with the artist or the manager until they are satisfied with the offer or edits made to the offer as illustrated at block 804. In certain embodiments, the agent may submit a response to the offer, for example “Accept”, “Decline”, “Edit”, etc. If the offer is edited or modified, a new offer (counter offer) is created, stored, and sent to the promoter.

At block 806, the server receives a response to the offer from the recipient. The response can be any type of response, for example, clicking a button in a home page, creating a new offer, indication for communication, etc. Upon receipt of the response from the recipient, the server processes the response and performs an appropriate action at block 808. In one embodiment, the server transmits a message to the buyer user, generates documents, updates the database, presents some content to the buyer user, etc. If the response includes a new offer, i.e., the recipient user edits the received offer; the new offer and detail are forwarded to the buyer user. The buyer user is also allowed to view and/or edit the new offer at block 810. If the buyer user edits the new offer, the server stores the edited offer as a new offer to the recipient at block 812. The buyer user can accept or reject the new offer. At block 814, a response from the buyer user is received. As with the recipient users, the buyer can communicate with the recipient regarding the new offer. At a decision block 816, a determination is made whether the negotiation on the offer is finished (e.g., rejected or accepted by all users). If the negotiation is successfully finished, a contract is generated at block 818. After the contract is generated or the negotiation is rejected, the routine completes at block 820. If the negotiation has not yet been finished, the routine repeats the above-mentioned steps.

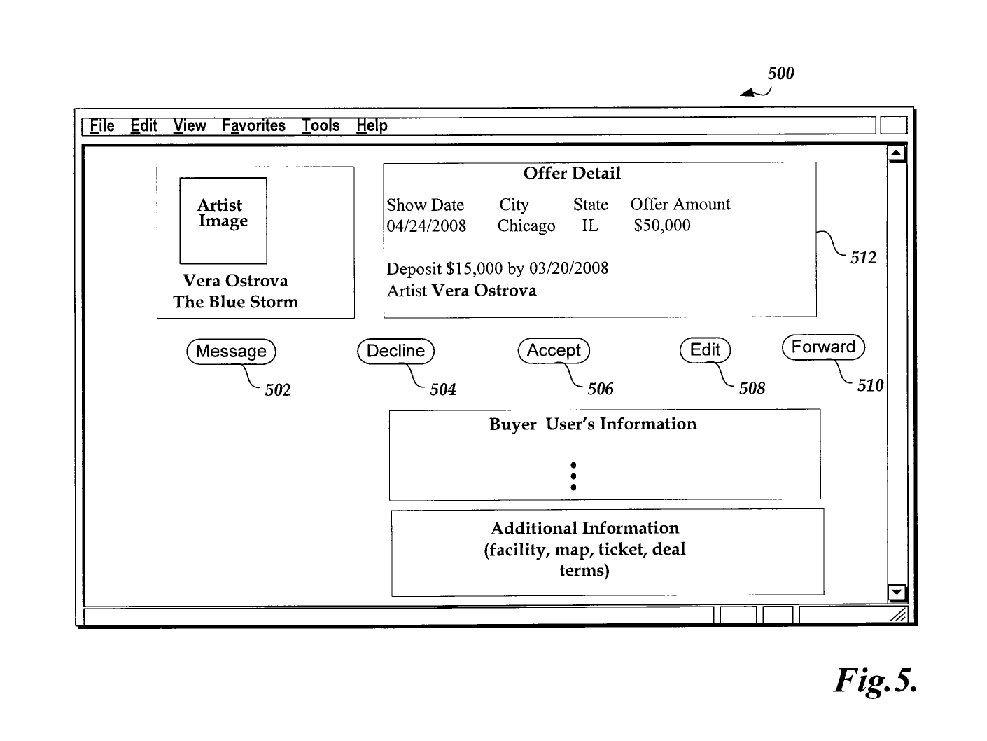

Referring to FIG. 5, a graphical user interface 500 presented in a Web page provides various interactive elements, such as selectable buttons 502-510, that allow users to create messages, respond to messages or access (e.g., view, modify) various objects stored in the database. Examples might include buttons that create response messages, buttons that allow users to modify offer details or to provide comments on an offer, buttons that allow users to reject the offer, buttons that allow users to create a new offer (counter offer), etc. In some embodiments, users who are relevant to the offer can communicate with each other to negotiate or discuss on terms and conditions of the offer. For example, if an agent receives an offer to purchase an appearance of an artist from a buyer, the agent may inform a manager and the artist about the offer. In a typical situation, after all the relevant users approve the offer, the offer can be accepted. Likewise, any additions or changes made in the received offer may need approval from all or some of the relevant users. Examples of functionality of certain buttons now will be given for certain entity types or users.

### For Buyer (e.g., Venue or Other Purchaser)

A button to reply may appear when a buyer (e.g., venue) receives any message from an agent regarding the offer. Once the buyer has replied for this message, the button may not appear. Also the button may be shown when there is any message from an agent. A button to forward may be presented if the particular offer is a new offer that is edited by an agent. In certain aspects, a button to edit may appear in two criteria: 1) when the offer is unread, or 2) if the offer is new and has been edited by an agent.

### For Agent

On reviewing the offer for the first time by an agent, a button to start a message box, or something similar, to send message to other users, may appear. In some embodiments, a button to reply may appear. In those embodiments, after sending a message through, this button may not be shown until the agent receives a reply message from other users, for example, from the buyer. On reviewing the offer for the first time by an agent, this button may not be visible. Once the offer has been approved by the agent and forwarded to a manager, the manager may respond to offer. A button to reply may then appear for the agent. After sending a reply message through, this button may not be shown until the agent receives a reply from the manager. Once the offer has been approved by the agent and forwarded to the artist, the artist may respond to the offer. A button to reply may then appear for the agent. After sending a reply message through, this button may not be shown until the agent receives a reply from the artist. A button to edit may appear from the initial stage of the offer. Once the offer details have been edited by the agent, this button may not be shown and a link to the previous offers related to this same booking may be shown.

### For Artist

As mentioned above, the buyer may send an offer directly to an artist. On reviewing the offer for the first time by an artist, a button to start a message box, or something similar, to send message to other users, may appear. In some embodiments, a button to reply may appear. In those embodiments, after sending a message through, this button may not be shown until the agent receives a reply message from the buyer. A button to edit may appear from the initial stage of the offer. Once the offer details have been edited by the agent, this button may not be shown and a link to the previous offers related to this same booking may be shown.

### Document Module

In certain embodiments, the server (or the document module) provides form documents specifically defined for an entertainment workflow or online community. Examples of documents may include Offers, Performance Agreement Contracts, Technical and Hospitality Riders, Input Lists, Performance Date Advancements, Confirmation Memos, and Deal Memos, etc. Such documents are dynamically generated and managed by the document module in certain aspects. It is noted that embodiments and aspects are discussed herein in terms of their applicability to the entertainment industry for ease of discussion. Thus, it should be appreciated that the various embodiments and aspects are applicable to other industries and communities. Examples of other industries or communities might include Outsourcing, Recruiting, Financial, Creative Services, Real Estate, Automotive, Equipment Leasing, Apartment-Rental Communities, etc.

In some embodiments, when the user creates a new document, an appropriate graphic user interface may be displayed in a web page so that the user can select the specific type of documents. In certain aspects, a list of document types that are permitted for the user to access may be obtained and corresponding templates are retrieved from the database. The list of available document types is presented to the user as a part of menu options. When the user selects one document type, a form document based on the template may be presented

Based on the selected document type, additional information may be retrieved from the booking record database (contract database) or obtained from the user. For example, while the user selecting a particular document type that requires specifying available dates, the system may obtain information on the available dates from the booking record of the user.

After validating the inputted data, the user will be provided with options for selecting additional documents to attach with the created document (base document). Then, the additional documents will be attached to the base document.

The created document may be saved and stored. In certain embodiments, a corresponding Portable Document Format (PDF) document may be generated and appended with the additional documents that were selected by the user. Subsequently, the PDF document may be stored in the database managed by a file system. Basic document details, including, but not limited to a document name, created date, created user information, user role, etc, will be logged in to the database (e.g., document database) as history information about the document. In addition, appropriate entries related to the created document may be provided in booking, contact and history tables. The booking, contact and history tables may be updated accordingly. In certain embodiments, various user activities, such as creating, editing, viewing, printing, exporting and downloading a document, may be logged, and stored as history. At any point of time, these history details could be retrieved from the database for a particular document.

### Financial Transaction Module

In certain embodiments, the server includes a financial transaction module that enables the buyer user and the artist or an agent of the artist to conduct financial transactions based on terms and conditions in the contract. For example, the buyer user may submit a payment request for the artist using a credit card. The server (the financial transaction module) may contact a secured third party financial service provider for performing financial transaction. In one embodiment, each user registered with the server may also be registered with the third party financial service provider for future financial transactions. Upon receipt of the payment request, the server provides the third party financial service with information about the buyer user and the artist and the payment request. The communication between the server and the third party financial service may be transparent from the users. If the transaction is successful, the server may notify the buyer user and the artist about the payment. The server may update the database related to the payment request. If the transaction is not successful due to lack of funds or other problem conditions, the server may notify the buyer about the failed payment. The buyer user may either cancel the transaction, or provide another account from which to originate payment. The server may request the buyer user to provide additional information. The financial transaction history is stored in the database.

### Online Community

In some embodiments, the server also provides an online community where performing artists and their respective agents, managers, and other business representatives can search for a business partner, exchange information, verify identities, and interact with each other. In one embodiment, the online community can include one or more different online communities, social networks, etc. The online community may provide a message board where a user can post messages, business opportunities, or blogs, feedback/review, communicate with each other, etc. In some embodiments, the online community may include a search module that allows a user to search information about other users based on search criteria. Example of the search criteria may be one or more “genres”, “locations”, “available times”, “account types”, etc. A user can browse or sort the search results which are generally a list of other users' profiles and view media content included in profiles.

A user can search any information available in the online community. A buyer user can scout and recruit performing artists based on the artists' profile, media content, and custom industry metrics provided by the server. In addition, a buyer user can post opportunities or possible leads or offers in the online community so that many users (artists or representatives of the artists) can view and respond to the postings. In one embodiment, users are able to view the various news added by the administrator of the online community. Each search result may include a hyperlink or visual indicator which, upon selection by a user, launches or opens a Web page including detail information related to the search results.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A system, comprising:
at least one data store including one or more databases, wherein the data store stores, user account information, user profile information and workflow documents;
a computing device communicatively connected with the at least one data store, wherein the computing device is operable to:
provide services for a first user to create a first offer related to a service;
present the first offer to a second user, wherein the second user is identified as a recipient of the first offer and allowed to view the first offer through a web browser on a user device of the second user;
enable the second user to submit a response to the first offer, the response indicating that the first offer is accepted, rejected, or modified; and
receive the response from the second user,
wherein if the response from the second user indicates that the first offer is modified, the computing device:
creates a second offer including the modification, and presents the second offer to the first user as a new offer, and
receives a response from the first user, the response from the first user indicating that the second offer is accepted, rejected or modified.

2. The system of claim 1, wherein if the response received from the second user indicates the first offer is accepted, a contract is generated in accordance with the first offer.

3. The system of claim 2, wherein if the response received from the first user indicates the second offer is accepted, the contract is generated in accordance with the second offer.

4. The system of claim 1, wherein the computing device enables the first user and the second user to negotiate over a communication method.

5. The system of claim 1, wherein the first user is an appearance purchaser and the second user is an artist.

6. The system of claim 1, wherein the first user is an appearance purchaser and the second user is a representative for an artist.

7. The system of claim 1, wherein the computing device is further operable to:
obtain profile information of the second user;
identify, from the profile information, a third user who is relevant to make a decision on the first offer; and
present the first offer to the third user.

8. The system of claim 1, wherein the first user and the second user execute the generated contract through an authenticated third party over networks.

9. The system of claim 3, wherein the computing device is further operable to:
obtain additional documents related to the contract;
merge the additional document with the contract; and
store the contract in the at least one data store.

10. The system of claim 3, wherein the contract is stored in the at least one data store with status information, the status information including created, reviewed, rejected, accepted, or edited.

11. The system of claim 1, wherein the computing device is further operable to:
receive a request to view a profile of the second user;
obtain the profile of the second user; and
present the profile of the second user to the first user, wherein the profile includes media content about the second user.

12. The system of claim 9, wherein the profile of the second user is presented in a web browser on a user device of the first user.

13. The system of claim 1, wherein the workflow documents include one of an offer, a contract, a rider, or a memo.

14. The system of claim 1, wherein the first and second users are associated with an entertainment community.

15. The system of claim 1, wherein the first and second users are associated with one of an outsourcing community, a recruiting community, a creative service community, a real estate community, or an equipment leasing community.

16. A method for providing entertainment resource management services over a network, the method comprising:
receiving a request from a first user to create an offer to purchase an appearance from a second user;
creating the offer based on the request;
updating an offer database to reflect the created offer with the first user information and the second user information;
notifying the second user about the created offer;
enabling the first user and the second user to negotiate the created offer through a desired communication method, wherein the desired communication method includes one of email, text messaging, voice, or creating a document;
if the negotiation is accepted, generating a contract based on the negotiation; and
updating a contract database and the offer database to reflect a result of the negotiation between the first user and the second user.

17. The method of claim 16, further comprising enabling the first user and the second user to execute the generated contract over the network.

18. The method of claim 16, wherein notifying the second user about the created offer includes enabling the second user to view or edit the created offer.

19. The method of claim 16, wherein the second user is notified through an email message including a link to access the created offer.

20. The method of claim 16, wherein the second user is an unrepresented artist.

21. The method of claim 16, further comprising enabling a third user to view or edit the created offer, wherein the third user is relevant to the created offer.

22. The method of claim 21, wherein the third user is an artist and the second user is a business representative of the artist.

23. The method of claim 16, further comprising:
receiving a request from the first user to search for the second user;
conducting a search on a profile database based on the request, wherein the request includes search criteria; and
presenting search results from which the first user can select the second user, the search results including profile information of each user in the search result.

24. The method of claim 23, wherein the search criteria is selected from genre, location, available time, or a fee range.

25. The method of claim 23, wherein the first user view the profile information of each user in the search result.

26. The method of claim 16, wherein the profile information includes multimedia content and business relationship with other people.

27. The method of claim 16, wherein notifying the second user about the created offer includes sending a notification via a desired communication method.

28. The method of claim 16, wherein creating an offer further includes:
obtaining a form document predefined for the offer;
obtaining information to fill the form document;
generating an offer document based on the form document, wherein the offer document is suitable for printing, transmitting, or downloading; and
storing the offer document in a document database.

29. The method of claim 16, wherein generating a contract further includes:
obtaining a form document predefined for the contract;
obtaining information and documents relevant to the contract;
generating an contract document based on the form document by merging the information and documents, wherein the contract document is suitable for printing, transmitting, or downloading; and
storing the contract document in a document database.

30. The method of claim 16, further comprising:
receiving a payment transaction request from the first user;
performing the payment transaction; and
notifying the first user about the payment transaction.

31. The method of claim 16, wherein the second user communicates with one or more third users who are relevant to make a decision on the created offer.

32. A system for providing entertainment procurement services among several users in electronic commerce, the system comprising:
a profile module for creating and managing user profile information, the profile information including media content uploaded by a first user;
an offer module for enabling the first user to create an offer for a second user and to view or modify the created offer, wherein the first user and the second user are allowed to interact with each other to negotiate the created offer;
a document module for allowing the user to create and manipulate a plurality of documents created while transacting electronic commerce; and
a financial transaction module for performing a secure financial transaction between the first user and the second user.

33. The system of claim 32, wherein the profile module enables a user to enter and update profile information of the user or profile information of other users if the user is a business representative of the other users.

34. The system of claim 32, wherein the financial transaction module receives a request of a financial transaction, forwards the request to a secured financial service provider to facilitate the financial transaction and receives a result and notifies a user about the result of the financial transaction.

35. The system of claim 32, further comprising a user interface module for presenting a graphic user interface where the first user and the second user transact commerce relating to entertainment procurement.

36. The system of claim 35, wherein the user interface module includes a link to access a list of users who seek talent to represent.

37. The system of claim 35, wherein the user interface module presents a list of offers created by the first user and a list of bookings converted from the offers created by the first user.

38. The system of claim 35, wherein the user interface module presents a list of offers received by the second user and a list of bookings converted from the offers received by the second user.

39. The system of claim 32, wherein the offer is created to purchase a performing appearance.

40. The system of claim 32, wherein the first user is one of a promoter, a venue, or a talent buyer and the second user is an artist or a representative of the artist.
